(19) United States
(12) Patent Application Publication
(10) Pub. No.: US 2012/0005939 A1
(43) Pub. Date: Jan. 12, 2012

(54) FINE LINE AND STRING THREADING DEVICE

(76) Inventor: Thomas A. Vandewalle, Columbus, OH (US)

(21) Appl. No.: 13/178,551

(22) Filed: Jul. 8, 2011

Related U.S. Application Data
(60) Provisional application No. 61/362,311, filed on Jul. 8, 2010.

(51) Int. Cl. A01K 91/04; A01K 97/00

(52) U.S. Cl. 43/4; 43/44.83

(57) ABSTRACT

A tool for holding a fishing lure eyelet, or other small structure, with a small aperture while a flexible line is extended through the aperture. Two pivotably mounted and spring-loaded levers have a jaw formed near one end and a handle near the opposite end. Each jaw has a pocket formed in its face. When the jaws are closed, preferably by a spring, the pockets register to hold a lure eyelet. The handles ends can be compressed to open the jaws against the spring. A tapered guide passage extends between the exterior of the jaws and the pockets to guide the line from a flared end to the aperture in the pocket where the guide passage narrows, and another passage guides the line out of the pocket. A blade and anvil on the handle ends can cut the line after a lure is tied.

### CROSS-REFERENCES TO RELATED APPLICATIONS

This application claims the benefit of U.S. Provisional Application No. 61/362,311 filed Jul. 8, 2010.

The above prior application is hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

The invention relates broadly to devices for assisting in the insertion of fine line, such as thread and fishing line, through small apertures, such as in needles, fishing hooks and others. More particularly, the invention relates to a device that clamps the structure defining the small aperture and has structural features that guide the fine line through the aperture.

It is well known that threading thin, flexible lines through small apertures is difficult. One example of a situation in which this is a significant obstacle is fishing, in which very thin monofilament fishing line must be inserted through a small aperture in an eyelet of a fishing hook or lure. Many people are unable to fully enjoy their sport or hobby due to the challenges of inserting lines through an eyelet and tying knots. The difficulty with threading is compounded by any lack of visual acuity or digital dexterity.

Many fish and expensive lures are lost as a consequence of failing to retie lures attached to a line that has nicks caused by underwater objects or teeth from previous catches. Frequent retying results in fewer lost lures and fish, but because of the difficulty of retying fishing line onto lures and hooks, most fishermen only undertake the task when it is obviously necessary.

When a fine line is to be threaded through a small hole, the line must be held by fingertips or pliers near the end of the line, and the line's tip is fed through the small aperture by the adjacent portion that is held by the fingertips. Once the tip extends through the aperture, the rest of the line follows in a carefully executed maneuver that involves spreading the fingertips while pushing along the axis of the line. This well-known test of a person's fine motor skills becomes more difficult with age, but it is those of retired age who are more likely to engage in leisure activities that include threading, such as fishing and sewing.

A great deal of skill is required to guide a thin, flexible line through a small eyelet and the process often requires several attempts to accomplish. This challenge is even greater under low light or poor weather conditions, which are typical of the fishing environment. The frustration of this task leads to lost time enjoying a hobby, and can even result in discontinuation of the hobby.

Conventional devices attempt to assist people with threading needles and hooks, but most such devices are costly, complicated, ineffective and/or inconvenient. Two commercial products that perform a similar function are on the market today. One device is the “Quik Tye” brand product based on U.S. Pat. No. 5,383,695 to Couper. The Couper device uses a scissor/pivot motion to secure the hook's eyelet between two rigid, parallel planar members with a fixed space between the ends of the members to aid in holding the hook in place. The Couper device is for tying small lures to tippets used in fly fishing. The device may damage the fishing line upon removal from the tool, and its use includes a motion that is awkward. Furthermore, the device's planar members may not pivot freely if dirt gets between them. Also, the Couper device may not facilitate consistent knot-tying because the line may unintentionally come out of the fixed pockets in the ends of the planar members.

Another prior art device is marketed under the trademark “20/20 Magnetic Tippet Threader” by Tight-Line-Enterprises of Tulsa, Okla. which uses a magnet to hold a fly hook in position for threading. This device requires the user to place the line into a narrow channel, and this may be a challenge for many users. The geometry of the device limits its use with larger-bodied lures. Heavier lures, which are more frequently used in fishing styles other than fly fishing, may not be adequately held in place by the magnet. The device does not assist in tying knots.

The need exists for a simple and conveniently available means for threading a fine line, which desirably also assists in tying knots.

### BRIEF SUMMARY OF THE INVENTION

This invention facilitates the task of threading a thin line through an eyelet, such as monofilament fishing line through the eyelet on a fishing lure or hook. The invention can be made of various sizes and shapes to fit various sizes and shapes of hooks, lures and other structures, such as needles.

The device is preferably spring-loaded for clamping onto many sizes of eyelets and other objects while maintaining the eyelet orientation in an open position to a passage that receives and guides the line. The line passage is flared on one end to a larger diameter, and tapers down to form a “funnel” to direct the line into the small aperture in the eyelet. The user squeezes the preferably spring-loaded levers to open the two jaws of the device. The user positions the eyelet into the preferably deformable gripping inserts of the jaws and then releases the levers to allow the jaws to clamp onto the eyelet by the spring's force. Once the eyelet is properly positioned and held securely in place by the torsion spring loaded device, the line may be threaded through the eyelet.

While clamping onto the eyelet, the voids in the jaws form the tapered passage through which the user pushes the line from the wide funnel end. The line is directed by the tapered passage into and through the eyelet, which is gripped in a position within the deformable inserts of the jaws. The user may then open the device, while holding the ends of the line on both sides of the eyelet, to release the threaded eyelet and line from the device. By design, this process is followed with no substantial risk of damaging the line.

When the jaws are closed, preferably by a spring or other bias, the pockets register to hold a lure eyelet perpendicular to a guide passage. The handles' ends can be compressed to open the jaws against the spring. A tapered guide passage extends between the exterior of the jaws and the pockets to guide the line from a flared end to the aperture in the pocket where the guide passage narrows, and another passage guides the line out of the pocket. A blade and anvil on the handle ends can cut the line after a lure is tied. An opening between the guide passage and the pivot point allows for quick tool connection to a lanyard when not in use and disconnection from a lanyard so the tool may be freely used to assist in tying knots.

The device also facilitates the operation of tying many common knots, such as the “improved clinch knot”, by providing a convenient means of grasping the hook and/or lure that has been threaded. Because the line is threaded through the tip of the device, which tip is substantially wider than the eyelet, the line forms a large loop where it passes through the eyelet. Thus, if knots are partially tied while the threaded eyelet is still positioned in the device, this creates line wraps and a larger opening for threading the line through the loop created between the eyelet and the first wrap of the knot.

The inventive device grips and holds a wide variety of hook and lure eyelets in an optimal position and helps the user direct the line through the eyelet with greater consistency and less effort. A variation of the device can be constructed to be used to thread a sewing needle with thread, and other variations will become apparent so that the concept can be used with other crafts and hobbies requiring the threading of small eyelets with thin lines.

The invention reduces the level of coordination needed between visual and fine motor skills and allows for fast, reliable threading. Those with undeveloped, declining or impaired vision and/or fine motor skills will also find this device useful in completing the task of threading a line through a small eyelet.

The invention provides a simpler, more intuitive functionality than prior devices. It is easier to manipulate between an opened and a closed configuration, and accommodates a wider variety of lines, eyelets and objects to be threaded. The device possesses superior gripping and positioning ability due to the flexibility of deformable material preferably used in the eyelet gripping inserts. Simple removal from a lanyard also improves the utility of the device to assist in tying many types of knots.

The device is preferably made from two elongated, rigid plastic levers that are hinged together between the ends and held in a closed position with a torsion or leaf spring. This results in a device having opposing jaw and handle ends that opens and closes in the manner of a clothes pin.

The eyelet-receiving pockets are preferably formed in a soft, compressible material that is able to accommodate a variety of eyelet sizes and shapes. The spring force biasing the jaws closed should be sufficient to compress the compressible material in which the eyelet-receiving pockets are formed, in order that any eyelets that are slightly larger than the pockets do not prevent the jaws from closing completely. However, the spring force must permit the average user to open the jaws by compressing the handle ends of the levers. The device is preferably made from weather-resistant materials because it will often be used outdoors.

All interior surfaces that receive the eyelet and line should be smooth to provide minimal resistance to the line as it progresses through the device. The “funnel” formed by the tapered passages must guide the line with a minimum of resistance to movement and is made of a durable material to hold up to typical conditions.

A preferred version of the device includes a line cutter to cut line from eyelets and to trim tag ends after knots are tied. Another feature of the device is that it allows easy connection to, and removal from, a simple lanyard or loop of cord. For example, the lanyard can be substantially permanently attached to a lanyard, such as near a region of the device that is out of the way. Alternatively, the device can otherwise removably attach to the lanyard, such as by providing voids in the jaw ends that clamp the lanyard when it is not in use. The opening motion then permits quick and easy removal from a lanyard during use.

One application of the device is as a tool used in relation to fishing. A version for fishing with small spincasting and baitcasting lures from approximately 1/32 oz. to 1/2 oz. is contemplated. Variations of the tool for fly fishing and ice fishing with extremely small lures are also contemplated, and may require smaller interior dimensions in the eyelet clamp inserts. Two or more sizes of inserts could be provided in a single device, but may not be necessary depending on the flexibility and durability of material chosen for the eyelet gripping inserts.

### BRIEF DESCRIPTION OF THE SEVERAL VIEWS OF THE DRAWINGS

FIG. 1 is a side view illustrating the preferred embodiment of the present invention.

FIG. 2 is an end view in perspective illustrating the embodiment of FIG. 1

FIG. 3 is an inside view in perspective illustrating one lever of the FIG. 1 embodiment.

FIG. 4 is an outside view in perspective illustrating the lever of FIG. 3.

FIG. 5 is an inside view in perspective illustrating the other lever of the FIG. 1 embodiment.

FIG. 6 is an outside view in perspective illustrating the lever of FIG. 5.

FIG. 7 is an inside view in perspective illustrating one tip of the embodiment of FIG. 1.

FIG. 8 is an outside view in perspective illustrating the other tip of the embodiment of FIG. 1.

FIG. 9 is an inside view illustrating the tip of FIG. 7.

FIG. 10 is a view in section illustrating the tip of FIG. 9 viewed along the line 10-10.

FIG. 11 is a view in perspective illustrating how a conventional hook is positioned relative to one lever of the embodiment of FIG. 1.

FIG. 12 is a schematic view in section illustrating the jaw end grasping an eyelet.

FIG. 13 is an end view in perspective illustrating the embodiment of FIG. 1.

FIG. 14 is a schematic view in section illustrating an alternative embodiment of the present invention.

FIG. 15 is a view in perspective illustrating the embodiment of FIG. 1 with a hook in an operable position, and thin line extending through the hook's aperture and the guide passage of the device.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 61/362,311 is incorporated in this application by reference.

The device 10 shown in FIG. 1 has a pair of levers 20 and 30 rotatably connected at a pivot 12. The handle ends 22 and 32, respectively, are formed by the ends of the levers 20 and 30 on one side of the pivot 12 and are preferably spaced apart when the device 10 is in the clamping configuration shown in FIG. 1. The jaw ends 24 and 34 are formed by the ends of the levers 20 and 30, respectively, on the opposite side of the pivot 12 as the handle ends 22 and 32. The jaw ends 24 and 34 are preferably biased together by a spring 14. Thus, upon application of a sufficient force clamping the handle ends 22 and 32 together, such as by grasping and clamping the handle ends 22 and 32 by hand, the force of the spring 14 holding the jaw ends 24 and 34 together is overcome, and the handle ends 22 and 32 move toward one another as the jaw ends 24 and 34 move apart. Release of the handle ends 22 and 32 allows the spring 14 to close the jaw ends 24 and 34.

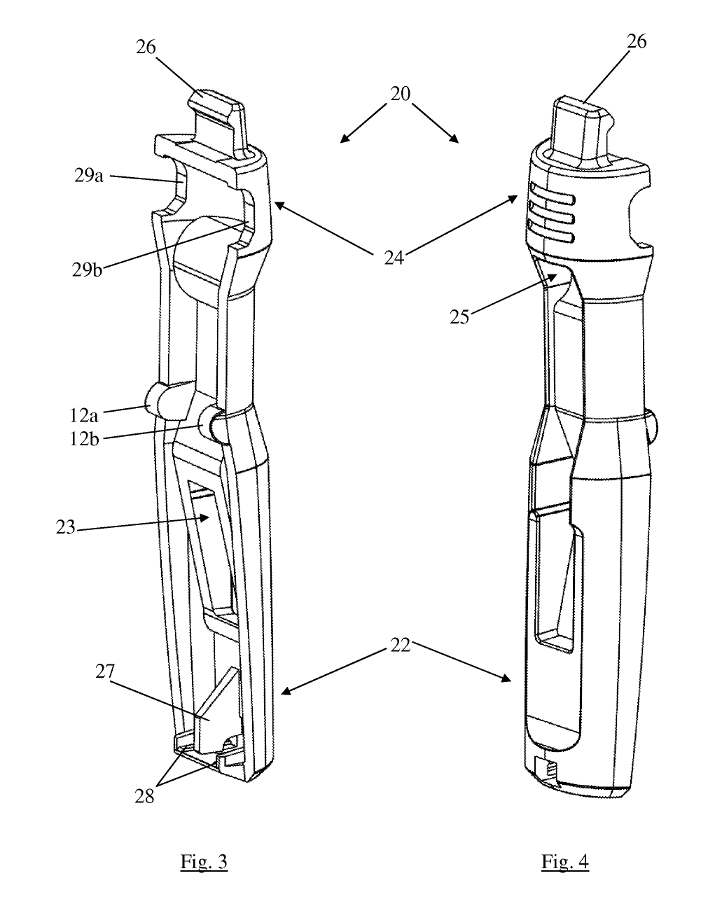

The lever 20 is shown in detail in FIGS. 3 and 4 from opposite sides. The levers 20 and 30 are preferably made of hard plastic, fiber-reinforced plastic or light metal. Of course, the levers can be made of any suitable material, and are contemplated to be injection-molded nylon. The lever 20 has a barbed tongue 26 at the jaw end 24, to which the soft tip 50 (not shown in FIGS. 3 and 4) is mounted or molded over during manufacture. The soft tip 50 is described in more detail in relation to the discussion of FIGS. 7-12.

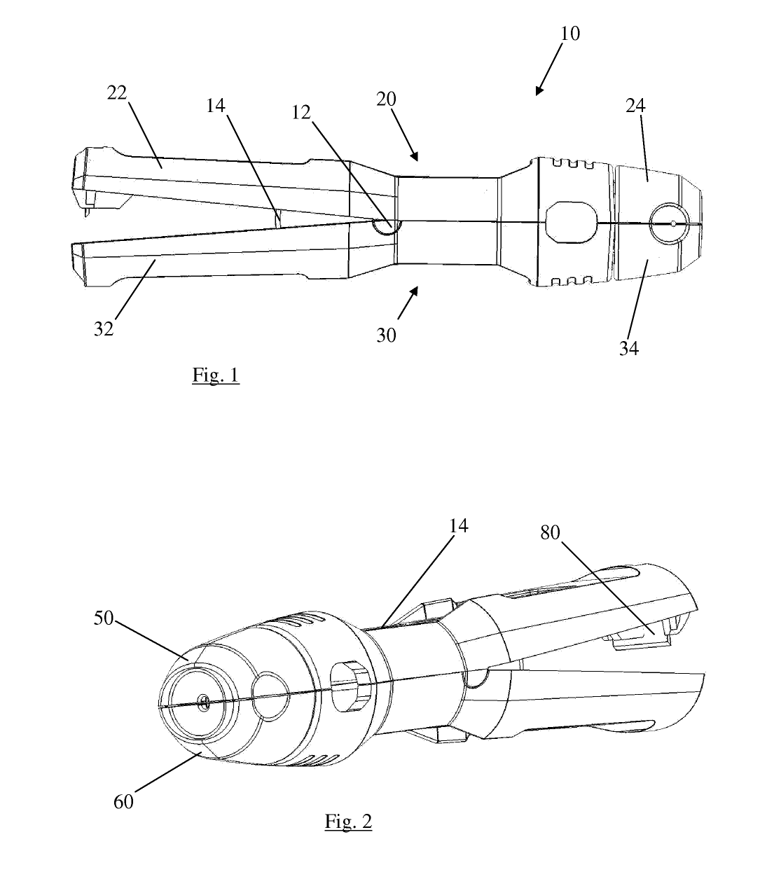

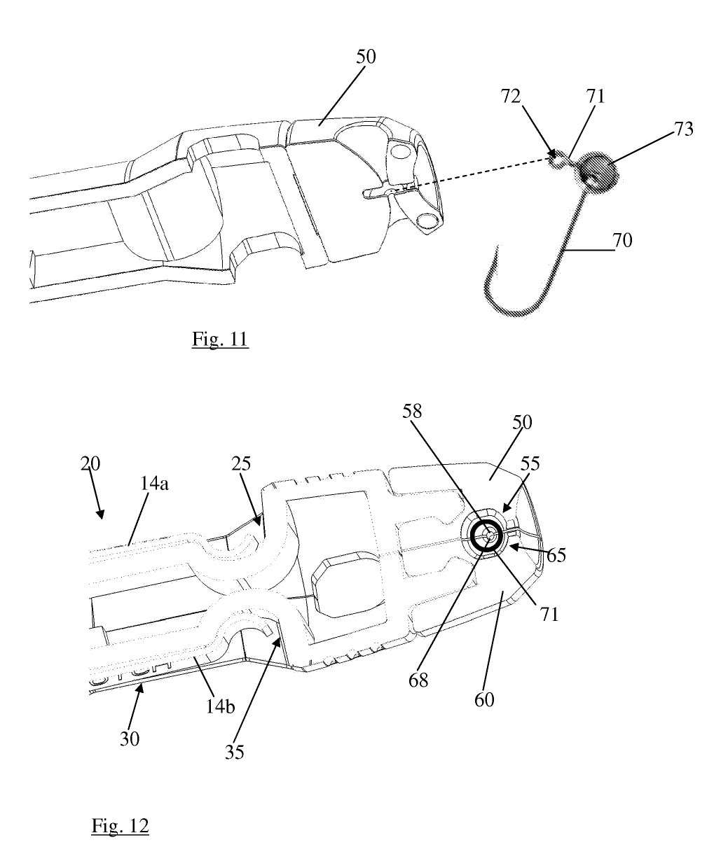

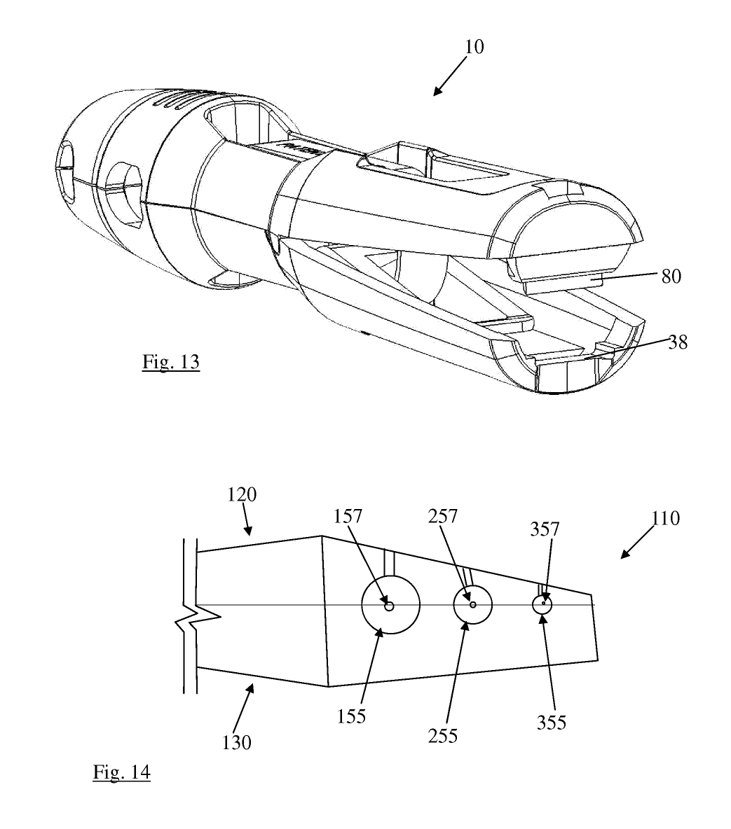

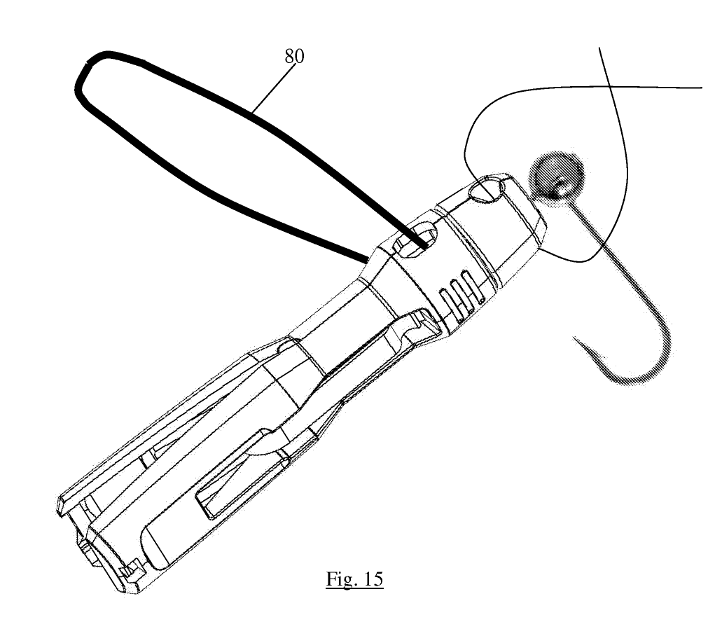

The pivot 12 includes the ears 12a and 12b, which have circular surfaces facing away from the remainder of the lever 20. The circular surfaces have coincident axes so that the lever 20 pivots around the axes as described above during gripping and subsequent movement of the handle ends 22 and 32 toward and away from one another. The blade 80, shown in FIG. 2, is held between the stanchion 27 and the seats 28. The U-shaped spring 14 has one leg 14a (as shown in FIG. 12) that extends through the aperture 23. The tip region of the spring leg 14a is curved inwardly to form a C-shape (see FIG. 12), and this C-shaped tip region rests in the complementary recess 25 (see FIGS. 4 and 12). This cooperation hinders unintentional movement of the spring 14 out of its desired position shown in FIG. 12.

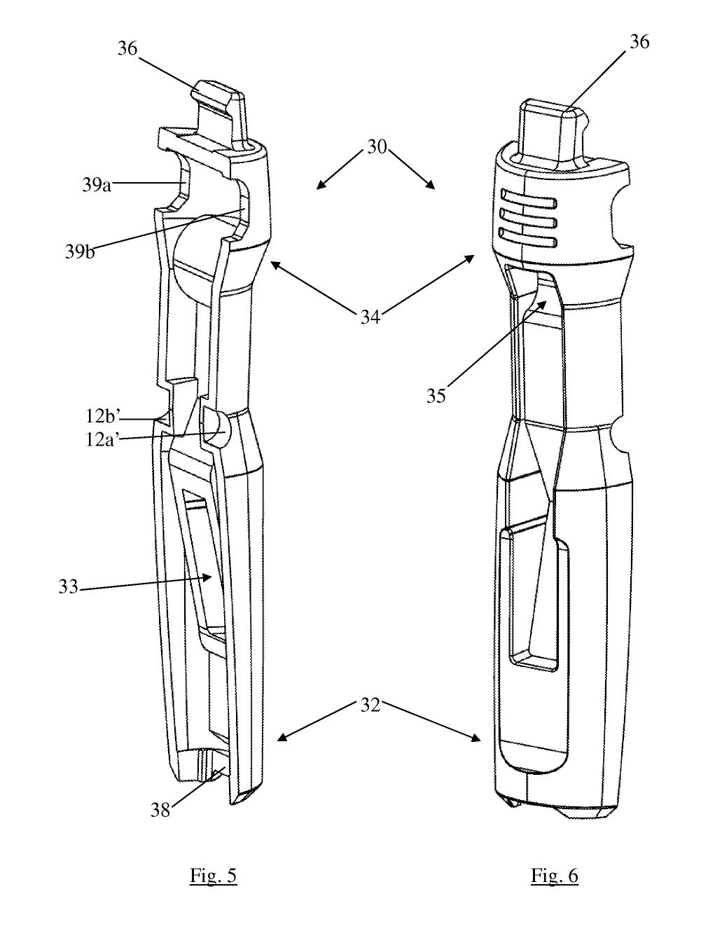

The opposing lever 30 is shown in detail in FIGS. 5 and 6 from opposite sides. The lever 30 has a barbed tongue 36 at the jaw end 34, to which the soft tip 60 (not shown in FIGS. 5 and 6) is mounted or overmolded. The pivot bearing slots 12a′ and 12b′ have circular surfaces facing away from the remainder of the lever 30. The circular surfaces have coincident axes so that the lever 30 pivots around the axes as described above during gripping and subsequent movement of the handle ends 22 and 32 toward and away from one another. The axes of the circular surfaces of the pivot bearing slots 12a′ and 12b′ are also coincident. Furthermore, the radii of the circular surfaces are the same as radii of the circular surfaces of the pivot ears 12a and 12b. The pivot ears 12a and 12b are received by the pivot bearing slots 12b′ and 12a′, respectively. During pivoting of the lever 20 relative to the lever 30, the circular surfaces of the pivot ears 12a and 12b slide against the circular surfaces of the pivot bearing slots 12a′ and 12b′ and the axes of all remain coincident. Thus, the combination of these cooperating components forms the pivot 12, which functions as a hinge but is much more easily assembled and disassembled. The pivot ears and bearing slots create a hinge that ensures consistent and repeatable alignment of the jaws onto an eyelet.

The U-shaped spring 14 has another leg 14b (see FIG. 12) that extends through the aperture 33 (FIG. 5). The tip region of the leg 14b is curved inwardly to form a C-shape that seats against the lever 30 and rests in the complementary recess 35. The blade 80, shown in FIG. 2, is aligned with the anvil 38 so that, upon clamping of the levers 20 and 30 to cause movement of the handle ends 22 and 32 toward one another, the sharp edge of the blade 80 seats against the anvil 38 at the extreme of the handle ends' 22 and 32 range of motion to cut material as described in more detail below.

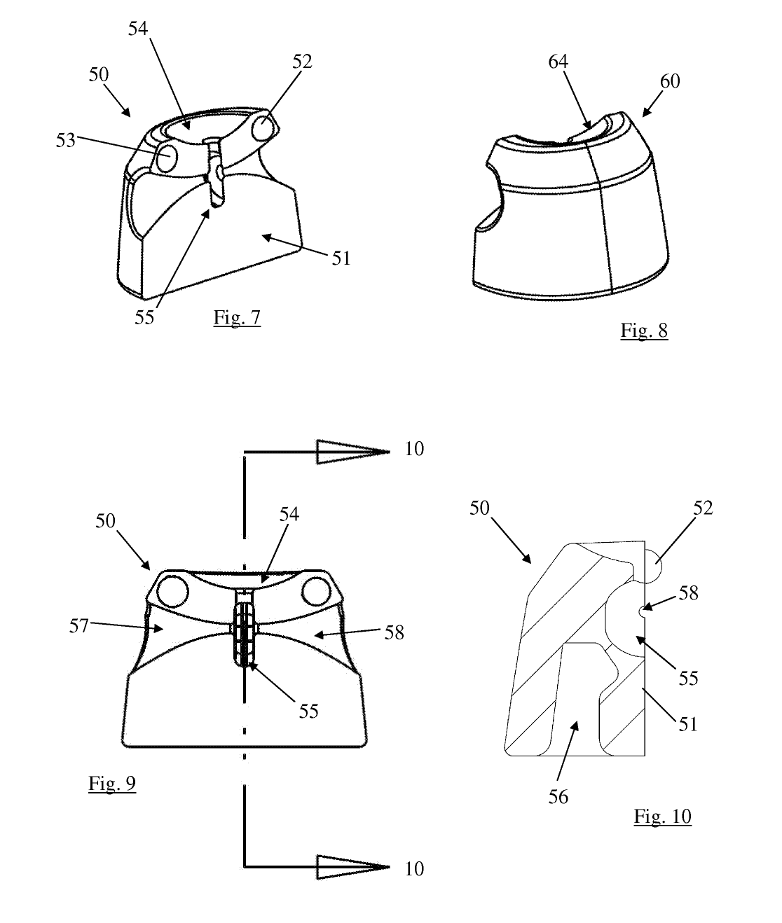

The tips 50 and 60 are shown in FIGS. 7 and 8, respectively, having a tapered cylindrical exterior with a planar inner face. The void 56 shown in the cross-sectional drawing of FIG. 10 has an interior shape that matches the exterior shape of the barbed tongue 26. Of course, other shapes for the cooperating components are contemplated. Because it is contemplated to mold the tips 50 and 60 to the levers 20 and 30, it is also contemplated to make corresponding shapes that prevent or reduce the ability to remove the tips 50 and 60 unintentionally. Overmolding adds a chemical bond to the mechanical connection between the two components.

The tip 50 is preferably made of an elastomeric material, such as rubber or polyurethane, but can be made of a rigid, non-elastomeric material except for around the inner face as will be described below. It is this elastomeric characteristic combined with the shapes of the void 56 and the tongue 26 that permit the barbed tongue 26 to be inserted in the void 56 when overmolding is not used. Insertion in this situation is carried out by extending the tongue 26 into the void 56 with some force to enlarge the void 56 to accommodate the barbed portion of the tongue 26. This continues until the distal end is seated against the deepest region of the void 56. Because the enlarged end of the barbed tongue 26 is seated in a similarly shaped portion of the void 56, the tip 50 will not fall off or otherwise separate unintentionally from the lever 20 due to the force that is required to deform the tip 50. A similar void is formed in the tip 60, and the tip 60 is made of a similar material to allow the tip 60 to be similarly mounted on the barbed tongue 36 of the lever 30.

The tips 50 and 60 are mounted on the jaw ends 24 and 34 of the levers 20 and 30, respectively, (as shown in FIG. 2) to form a portion of the jaw ends 24 and 34 of the device 10. The terms “jaw” and “jaws” are used herein to refer to opposing structures that move between a separate position and a contact position, in the manner of jaws of an animal that move similarly to grasp and release an object. The tips 50 and 60 have retention voids, described below, that enhance the ability of the device 10 to grip and retain a small object that has a smaller aperture formed therein. Guide passage voids, described below, intersect the retention voids and guide a fine line or string through the aperture in the small object. One embodiment of the tips 50 and 60 and these voids is described immediately below in more detail, but it should be understood that other variations are contemplated and will be apparent to a person having ordinary skill in the technology from the description herein.

The tips 50 and 60 are designed to retain a portion of a fishing hook, such as an end of the hook 70 shown in FIG. 11. Other tips are contemplated to hold other structures, such as sewing needles and other fishing hooks with different shapes. These contemplated tips will be modified from the shapes of the tips 50 and 60 in ways the person having ordinary skill will recognize as being necessary from the description herein.

The tip 50 will now be described in detail, but it should be understood that because the tips 50 and 60 are substantially identical the tip 60 has a corresponding structure for every described structure on the tip 50. Not all of the corresponding structures on the tip 60 are described herein, but it should be understood that they nevertheless exist on the tip 60.

The tips 50 and 60 are shown in FIGS. 7 and 8 facing one another and having complementary shapes to permit them to be placed in close proximity, or touching, to create jaws that hold the hook 70 and permit thin line to be extended easily through the hook's aperture 72. The planar face 51 and a similar planar face on the tip 60 permit the tips 50 and 60 to seat against one another as shown in FIG. 2. The protuberance 52 (best viewed in FIG. 10) is inserted at least partially into the aligned recess of the tip 60, and the protuberance of the tip 60 is inserted at least partially into the aligned recess 53. The protuberances and recesses ensure alignment of the faces of the tips 50 and 60.

In the facing orientation shown in FIGS. 1 and 2, the face 51 is spaced a very small distance, such as 0.5 millimeters to 1.0 millimeter, from the corresponding face of the tip 60. In this configuration, the tapered cylindrical outer and planar inner surfaces of the tips 50 and 60 are aligned with one another as shown in FIGS. 1 and 2. Of course, other shapes, such as complementary curves and angled planes, are contemplated that permit the tips 50 and 60 to face one another in close proximity. These structures will become apparent to the person of ordinary skill from this description. These complementary structures are considered equivalent to the planar faces of the tips 50 and 60.

The pocket 55 is formed in the face 51 as shown in FIGS. 7 and 10. The pocket 55 is shaped to permit an eyelet 71 of the hook 70 to be inserted into the pocket 55 and has a depth of about half of the eyelet's thickness. The eyelet 71 is typically a toroid at the end of a cylindrical stem, and the line or string will be inserted through the aperture 72 formed in the eyelet 71 as described below. The opposite half of the eyelet 71 extends about halfway into the corresponding pocket 65 (see FIG. 12) in the tip 60 when the tips 50 and 60 are clamped together as shown in FIGS. 1 and 2. Thus, the eyelet 71 is gripped between the two tips 50 and 60 and held in position while a fine line can be inserted through the aperture 72.

As noted above, the tips 50 and 60 are preferably made of a soft, flexible material, such as rubber or a synthetic elastomer. The elastomeric characteristics of the tips 50 and 60 allow for compression of the tip material when an eyelet is slightly larger than the pockets 55 and 65, but also allows the tips 50 and 60 to retain an eyelet that is smaller than the pockets 55 and 65. The eyelet shaft opening at the tip is small enough to hold the shaft of small eyelets in the desired aperture orientation yet flexible enough to accept large eyelets. Thus, although it would be ideal to form the pockets 55 and 65 and shaft opening with exactly the same shape and size as the exterior of every eyelet, this is not practical because there are many shapes and sizes of eyelets. Therefore, an elastomeric material with a pocket formed of an average or median sized pocket holds eyelets that are smaller, and larger, than the pockets. Although it is preferred that the entire tips 50 and 60 are made of an elastomeric material, it is contemplated that the material surrounding the pockets 55 and 65 can be the only elastomeric material in a rigid, non-elastomeric tip if formed in and around the pockets 55 and 65 to have a similar effect as a completely elastomeric tip.

There are two tapered, preferably approximately conical, guide passage halves 57 and 58 extending along a line through the pocket 55. The passage halves 57 and 58 are best viewed in FIG. 9 and taper from the largest diameter at the outer wall of the tip 50 to the smallest diameter where the passage halves 57 and 58 intersect the pocket 55. In the same way that the pocket 55 has a corresponding pocket 65 on the tip 60 that aligns with the pocket 55 when the jaw ends are closed, the passage halves 57 and 58 have corresponding passage halves on the tip 60 that align therewith to form tapered, preferably conical guide passages extending in opposite directions from the pockets 55 and 65. This is shown in FIG. 12 where the passage half 58 is shown facing and registering with a corresponding passage half 68, which halves taper to a small passage that intersects the aperture 72. The gently sloping sidewalls of the guide passages guide a fine line that is inserted into the outer, flared portion thereof toward the pockets 55 and 65 that retains the eyelet 71 of the hook 70. The axes of the guide passages are coincident and pass approximately through the center of the pocket 55 (as shown in FIGS. 10 and 12), and therefore the fine line is guided thereby through the aperture 72.

Therefore, when the tips 50 and 60 are seated against one another, as shown in section in FIG. 12, the eyelet 71 rests in and is gripped by the portion of the tips defining the pockets 55 and 65 and the stem gripping orifice. The eyelet 71 is held with its plane substantially perpendicular to the axis of the guide passages, which align with the aperture 72, to permit insertion of string. Furthermore, the recesses 54 and 64 form a cavity (see FIG. 2) into which the hook's spherical portion 73 can rest for firm gripping. The stem between the eyelet 71 and the spherical portion 73 extends through an orifice connecting the recesses 54 and 64 with the pockets 55 and 65.

With the device 10 and hook 70 thus arranged, the portion of the hook 70 that will receive the fine line is firmly gripped between the tips 50 and 60 with the aperture 72 aligned with the guide passage halves 57 and 58 and corresponding, minor image guide passages of the tip 60. This configuration permits the tip of a fine line to be extended into the larger diameter, flared portion of one guide passage on one side of the tips 50 and 60, and, upon further manual insertion, to be further extended through the aperture 72 and the guide passage on the opposite side of the tips 50 and 60. In this process, the guide passages guide the line through at their narrowest regions through the aperture.

Once the line has been extended entirely through the tips 50 and 60, the terminal end of the line can be pulled further to extend more line through the eyelet, and then that terminal end of the line can overlap the portion of the line that extends away from the device 10 to form a loop above the tips 50 and 60 as shown in FIG. 15. Then the line can be tied or otherwise manipulated. At this point, the handle ends 22 and 32 can be compressed to open the jaw ends 24 and 34, thereby separating the tips 50 and 60. Upon separation, the threaded hook 70 can be removed from the jaw ends 24 and 34 and the knot can be firmly tightened up to the eyelet.

In a preferred embodiment, while the device 10 still grips the hook 70, the line is drawn above the tips 50 and 60 and formed into a loop or other knot-tying configuration as shown in FIG. 15. Then the entire device 10 is rotated about its longitudinal axis, which twists the line in the manner that a conventional fishing lure knot is started. Thus, the user can use the device 10 as an extension of the hook or lure, and spin the device 10, which spins the hook or lure, thereby causing the line to react accordingly. Therefore, it should be understood that many knots can be tied, partially or completely, with the hook gripped in the device 10. The user then simply loops the tip of the line in a manner that is conducive to forming a knot, and then tightens the line, possibly while simultaneously releasing the hook 70.

When tying a knot, some excess line inevitably extends from the knot, and this can be removed by extending the line through the handle ends of the levers 20 and 30 between the blade 80 and the anvil 38. When the levers 20 and 30 are pivoted about the pivot 12 to open the jaw ends 24 and 34, the space between the blade 80 and the anvil 38 is reduced to zero, thereby severing any line that is interposed between the two. The lanyard 80 extended through the apertures formed by the cavities 29a, 29b, 39a and 39b on the levers 20 and 30, as shown in FIGS. 3 and 5, would typically be released prior to forming a knot in order to avoid tangling the lanyard 80. The cavities 29a, 29b, 39a and 39b open when the handle ends are clamped, thereby allowing the release and re-insertion of the lanyard 80.

It should be understood that, although it is contemplated to use two funnel shaped guide passages on the opposite sides of the eyelet-holding pocket, it is contemplated that only one such funnel shaped passage is necessary. In this situation, a straight or otherwise shaped passage can be formed to permit the fine line to exit from the eyelet aperture.

It should also be understood that, as pointed out above, although a single pocket with passages leading into and out of the pocket is illustrated, devices with multiple pockets and guide passages are contemplated. For a single pocket fishing line threader as previously described, the pocket should be sized to fit eyelets that are about 0.025 to 0.069 inches thick and 0.08 to 0.194 inches in diameter. The diameter of the narrow end of the guide passage should be about 0.03 inches, and the large end should be about five to ten times larger in diameter. The stem orifice should be able to accommodate stems from about 0.01 to 0.08 inches long and from about 0.024 to about 0.070 inches in diameter.

The device 110 of FIG. 14 has levers 120 and 130 pivotably mounted to one another to form handle ends (not illustrated) and jaw ends in which the pockets 155, 255 and 355 are formed, having various sizes. Upon opening of the jaws of the device 110, the most appropriate pocket size is selected, and the jaws are closed. Then string is extended through the associated one of the guide passages 157, 257 or 357, each of which is appropriately sized to the typical size ranges of the eyelets that will be placed in the pockets. Likewise, the stem orifice varies according to the typical diameters and lengths for the eyelets associated. The device 110 provides variously-sized structures and voids on the same device so that variously-sized hooks can be used without loosely-gripping any hook.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A tool for holding a structure while a flexible line is extended through an aperture in the structure, the tool comprising:
(a) a first jaw with a first pocket formed in a face of the first jaw;
(b) a second jaw with a second pocket formed in a face of the second jaw, the second jaw being pivotably mounted to the first jaw to pivot from a closed position in which the faces are adjacent one another with the second pocket in registration with the first pocket, and an open position in which the first and second pockets are spaced from one another;
(c) a first tapered guide passage portion formed in the face of the first jaw on one side of the first pocket;
(d) a second tapered guide passage portion formed in the face of the second jaw on one side of the second pocket, wherein the first and second tapered guide passage portions register with one another when the jaws are in the closed position, thereby forming a tapered guide passage extending from the first and second pockets to a flared opening on an outer surface of the jaws;
(e) a first passage portion formed in the face of the first jaw on an opposite side of the first pocket from the first tapered guide passage portion; and
(f) a second passage portion formed in the face of the second jaw on an opposite side of the second pocket from the second tapered guide passage portion, wherein the first and second passage portions register with one another when the jaws are in the closed position, thereby forming a passage extending from the first and second pockets to an opening on an outer surface of the jaws substantially opposite the flared opening.

2. The tool in accordance with claim 1, further comprising a first lever and a second lever pivotably mounted to the first lever by a pivot mounted between opposing lever ends, wherein the first jaw is formed near a jaw end of the first lever and the second jaw is formed near a jaw end of the second lever, a first handle end is formed near an end of the first lever opposite the first jaw end and a second handle end is formed near an end of the second lever opposite the second jaw end for compressing to pivot the first and second jaws from the closed position to the open position and releasing to pivot the first and second jaws from the open position to the closed position.

3. The tool in accordance with claim 2, further comprising a bias mounted to the first and second levers to bias the first and second jaws toward the closed position.

4. The tool in accordance with claim 2, further comprising a blade mounted to the first lever at the handle end and an anvil formed on the second lever at the handle end and spaced from the blade for severing material that is interposed between the anvil and the blade when the jaws are pivoted to the open position.

5. The tool in accordance with claim 4, further comprising an opening in at least the first lever between the first jaw and the pivot through which a lanyard can extend.

6. The tool in accordance with claim 1, wherein materials forming at least a region around the first pocket and materials forming a region around the second pocket are compressible.

7. The tool in accordance with claim 6, wherein the first jaw is made of an elastomeric material and the second jaw is made of an elastomeric material.

8. The tool in accordance with claim 1, wherein the first passage portion and the second passage portion are tapered.

9. The tool in accordance with claim 1, further comprising a first stem orifice extending from the first pocket to an outer surface of the first jaw, and a second stem orifice extending from the second pocket to an outer surface of the second jaw.

10. A tool for holding a fishing lure while a flexible line is extended through an aperture in the lure's eyelet, the tool comprising:
(a) a first lever having a first jaw formed near a jaw end of the first lever and a first handle end near an end of the first lever opposite the first jaw end, the first jaw having a first pocket formed in a face of the first jaw;
(b) a second lever having a second jaw formed near a jaw end of the second lever and a second handle end near an end of the second lever opposite the second jaw end, the second jaw having a second pocket formed in a face of the second jaw, wherein the second lever is pivotably mounted to the first lever by a pivot mounted between the first and second jaw ends and the first and second handle ends to pivot the first and second jaws from a closed position in which the faces are adjacent one another with position in which the first and second pockets are spaced from one another and the lure eyelet can be removed from the pockets;
(c) a bias mounted to the first and second levers to bias the jaws toward the closed position;
(d) a blade mounted to the first lever at the handle end and an anvil formed on the second lever at the handle end and spaced from the blade for severing material that is interposed between the anvil and the blade when the jaws are pivoted to the open position;
(e) a first tapered guide passage portion formed in the face of the first jaw on one side of the first pocket;
(f) a second tapered guide passage portion formed in the face of the second jaw on one side of the second pocket, wherein the first and second tapered passage portions register with one another when the jaws are in the closed position, thereby forming a tapered guide passage extending from the first and second pockets to a first flared opening on an outer surface of the jaw;
(g) a third tapered guide passage portion formed in the face of the first jaw on an opposite side of the first pocket from the first tapered guide passage portion; and
(h) a fourth tapered guide passage portion formed in the face of the second jaw on an opposite side of the second pocket from the second tapered guide passage portion, wherein the third and fourth tapered guide passage portions register with one another when the jaws are in the closed position, thereby forming a tapered guide passage extending from the first and second pockets to a second flared opening on an outer surface of the jaw substantially opposite the first flared opening for inserting a fishing line through the second flared opening and into the eyelet's aperture;

11. The tool in accordance with claim 10, wherein materials forming at least a region around the first pocket and materials forming a region around the second pocket are compressible.

12. The tool in accordance with claim 10, wherein the first jaw is made of an elastomeric material and the second jaw is made of an elastomeric material.

13. The tool in accordance with claim 12, further comprising a first stem orifice extending from the first pocket to the outer surface of the first jaw, and a second stem orifice extending from the second pocket to the outer surface of the second jaw.
